(19) United States
(12) Patent Application Publication
(10) Pub. No.: US 2024/0153221 A1
(43) Pub. Date: May 9, 2024

(54) MIXED REALITY FOOD AND BEVERAGE APPARATUS

(71) Applicants: Laara Garcia, Seattle, WA (US); Julia Alma Bruk, Seattle, WA (US)

(72) Inventors: Laara Garcia, Seattle, WA (US); Julia Alma Bruk, Seattle, WA (US)

(21) Appl. No.: 18/502,784

(22) Filed: Nov. 6, 2023

Related U.S. Application Data
(60) Provisional application No. 63/382,482, filed on Nov. 4, 2022.

(51) Int. Cl. G06T 19/00; G06K 7/14; G06V 20/68

(52) U.S. Cl. CPC G06T 19/006; G06K 7/1447; G06V 20/68

(57) ABSTRACT

A system to enable display of an augmented reality (AR) image on a user device is disclosed. The system may include an identifier apparatus removably attached to a consumable item. The identifier apparatus may include a unique identifier associated with the consumable item. The system may further include an AR unit. The AR unit may receive a command signal associated with the unique identifier from the user device when the user device performs a predefined action in proximity to the identifier apparatus. The AR unit may further store information associated with the consumable item. The AR unit may generate the AR image based on the information associated with the consumable item responsive to obtaining the command signal. The AR unit may further transmit the AR image to the user device.

### TECHNICAL FIELD

The present disclosure relates to a mixed reality food and beverage apparatus, and more particularly, to a mixed reality food and beverage apparatus that facilities a user to view supplementary information or art work associated with a food item or a beverage in an augmented reality environment.

### BACKGROUND

Many times, a user may desire to know about supplementary or additional information about a food item or a beverage that the user may be consuming. For example, the user may desire to know about the ingredients included in the food item, ingredient source, nutritional information, artistic interpretation associated with the food, and/or the like. Typically, in such instances, the user searches on the Internet or interacts with experts to gather the supplementary information. Such methods of gathering supplementary information are cumbersome, time consuming and mostly ineffective.

Further, there are limited means for manufacturers of such food items and beverages to market supplementary information about their products, so that the consumers may be enticed to buying the manufacturers' products.

In light of the above, a system is needed that facilities users to conveniently access supplementary information about food items and beverages, and manufacturers to efficiently market supplementary information about their products or a story about their products, either an artistic story or a factual origin story.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts an example first embodiment of an identifier apparatus usage in accordance with the present disclosure.

FIG. 3 depicts an example second embodiment of an identifier apparatus usage in accordance with the present disclosure.

FIG. 4 depicts an example third embodiment of an identifier apparatus usage in accordance with the present disclosure.

FIG. 5 depicts an example fourth embodiment of an identifier apparatus usage in accordance with the present disclosure. Other examples may exist and some are included in descriptions here throughout.

FIG. 6 depicts a flow diagram of an example method to enable display of an augmented reality (AR) image on a user device in accordance with the present disclosure.

### DETAILED DESCRIPTION

Overview

The present disclosure describes a system to enable display of an augmented reality (AR) image on a user device. The system may include an identifier apparatus or an “anchor device” that may be removably attached or adhered to a consumable item such as a food item or a beverage item. Alternatively, the anchor may actually be a part of the consumable as well. The identifier apparatus may include a unique identifier associated with the consumable item. The unique identifier may be, for example, a Quick Response (QR) code or an image tag associated with the consumable item. When the user scans the unique identifier included in the identifier apparatus, the system may render an AR image based on or including information associated with the consumable item on the user device, so that the user may conveniently view the information. The information associated with the consumable item may include, for example, ingredient list, a recipe, nutrition information, an ingredient origin, an art work, and/or the like associated with the consumable item. In this manner, the system enables the user to conveniently view information associated with the consumable item in an AR environment. This AR environment can include visual imagery, three-dimensional imagery, tactile response in a device, or even sound. The AR environment can be supplemental to the food and related to it, or it can be related to an overall experience of an event or the space around the food.

In some aspects, along with the identifier apparatus, the system may further include an AR unit. The AR unit may be a part of the identifier apparatus or may be hosted on a server. The AR unit may include a transceiver, a memory and a processor. The transceiver may be configured to receive a command signal associated with the unique identifier from the user device when the user device performs a predefined action in proximity to the identifier apparatus. The predefined action may be, for example, scanning the unique identifier using a user device camera or disposing/bringing the user device within a predefined distance from the identifier apparatus. Further, the memory may be configured to store the information associated with the consumable item.

The processor may be communicatively coupled with the transceiver and the memory, and may be configured to obtain the command signal and the information associated with the consumable item. Further, the processor may be configured to generate the AR image based on the information associated with the consumable item responsive to obtaining the command signal, and transmit (via the transceiver) the AR image to the user device. The user device may render the AR image on a user device display screen responsive to receiving the AR image. The AR image or experience may also be displayed via sound through an associated device, tactile response in an associated device, or displayed without a screen via other wearables or devices.

As described above, the unique identifier may be a QR code or an image tag. In other aspects, the unique identifier may be at least one of a near field communication (NFC) transceiver, a radio frequency identification (RFID) transceiver, an ultra-wideband (UWB) transceiver and a Bluetooth low energy (BLE) transceiver.

In some aspects, the identifier apparatus may further include a base. The unique identifier may be disposed of on the base. The base may be made of at least one of wood, plastic, paper and glass. Further, in some aspects, the base may be shaped as a popsicle stick holder or a drink key. In other aspects, the base takes other forms, for instance a bowl, a bone, a ice cream cone, or other food holder.

In further embodiments of the present disclosure, a method to enable display of an AR image on the user device is disclosed. The method may include obtaining, by the processor, the command signal from the transceiver and the information associated with the consumable item from the memory. The method may further include generating, by the processor, the AR image based on the information associated with the consumable item responsive to obtaining the command signal. Further, the method may include transmitting, by the processor via the transceiver, the AR image to the user device.

In yet another embodiment of the present disclosure, a non-transitory computer-readable storage medium in a distributed computing system is disclosed. The non-transitory computer-readable storage medium has instructions stored thereupon which, when executed by a processor, cause the processor to obtain the command signal from the transceiver and the information associated with the consumable item from the memory. The processor further generates an AR image based on the information associated with the consumable item responsive to obtaining the command signal, and transmits the AR image to the user device.

The present disclosure discloses a system that enables a user to conveniently view supplementary or additional information associated with a food item or a beverage item or experiences or information related to a venue or event at which the food or beverage is served. Since the identifier apparatus is adhered or attached to the food item or the beverage item container, the user does not have to search on the Internet or interact with experts to gather the supplementary information. The user may simply scan the identifier apparatus to conveniently view the supplementary information in an AR environment. Further, the system enables food or beverage item manufacturers to conveniently market supplementary information about their products, thus adding another marketing angle to their growth strategy.

These and other advantages of the present disclosure are provided in detail herein.

### ILLUSTRATIVE EMBODIMENTS

The disclosure will be described more fully hereinafter with reference to the accompanying drawings, in which example embodiments of the disclosure are shown, and not intended to be limiting.

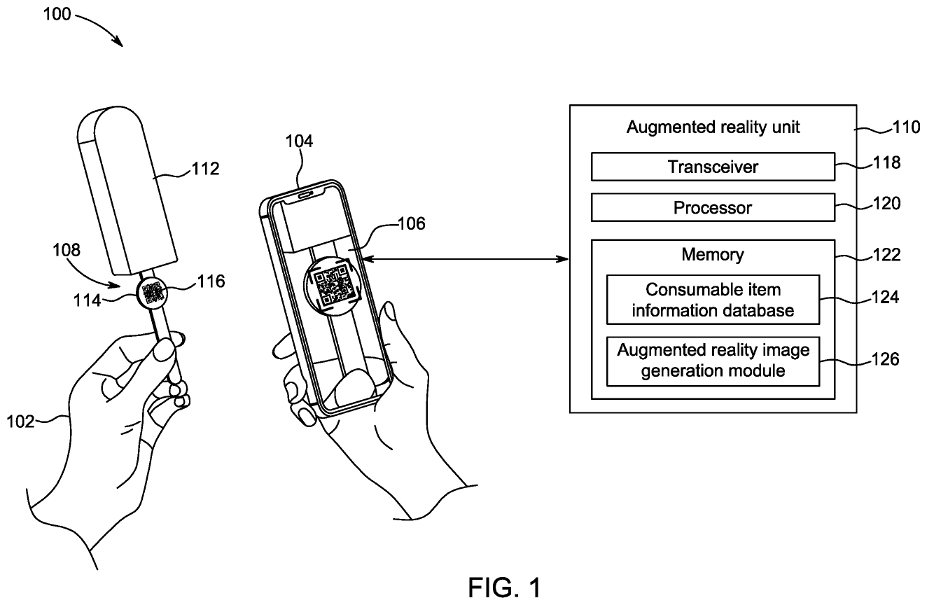

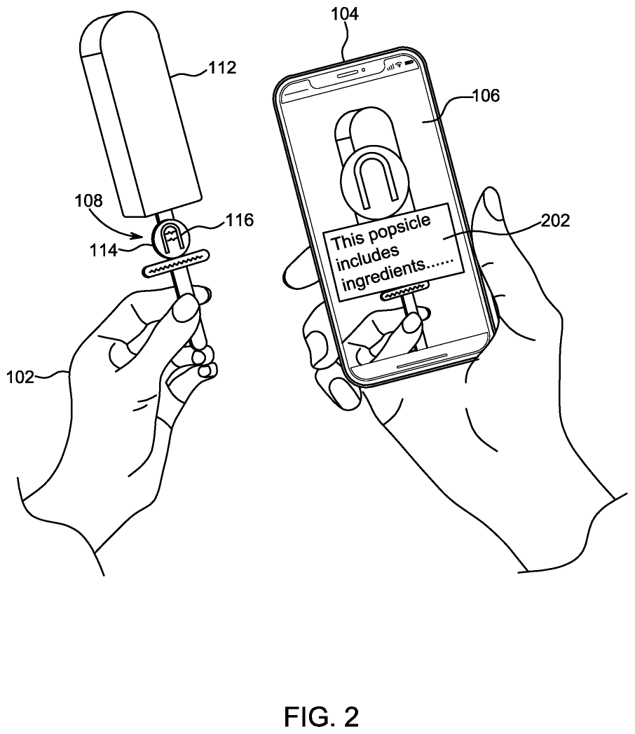

FIG. 1 depicts an example environment 100 in which techniques and structures for providing the systems and methods disclosed herein may be implemented. FIG. 1 will be described with continued references to FIGS. 2-5. The environment 100 may include a user 102 operating a user device 104. The user device 104 may be, for example, a mobile phone, a tablet, a smartwatch, a laptop, or any other similar device with communication capability and a display screen. In some aspects, the user device 104 may include a user device camera (not shown) and a display screen 106. The user device camera may be configured to capture real-world images, and the display screen 106 may be configured to display the real-world images/view captured by the user device camera and render mixed reality or augmented reality (AR) images over the real-world view.

The environment 100 may further include an augmented reality system (“system”) that may enable display of an AR image on the user device 104 (specifically, the display screen 106). The system may include an identifier apparatus 108 and an AR unit 110. The system may generate and render an AR image on the display screen 106 when the user 102 “scans” the identifier apparatus 108 by using the user device camera or disposes/brings the user device 104 within a predefined distance in proximity to the identifier apparatus 108. The AR image may be associated with an object or item to which the identifier apparatus 108 may be adhered to, as described in detail later below.

The identifier apparatus 108 may be an anchor device or a holder that may be removably attached or adhered to a consumable item 112. The consumable item 112 may be a food item or a beverage item. In the exemplary aspect depicted in FIG. 1, the consumable item 112 is shown to be a popsicle, and the identifier apparatus 108 is attached to the popsicle stick. The exemplary aspect depicted in FIG. 1 should not be construed as limiting, and the identifier apparatus 108 may be removably attached or adhered to any other food item or beverage (or beverage container/bottle), without departing from the scope of the present disclosure.

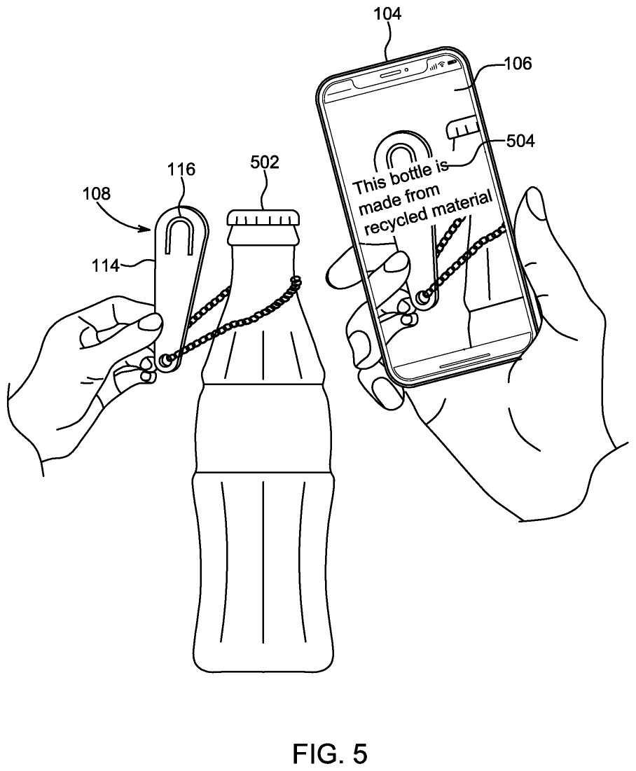

In some aspects, the identifier apparatus 108 may include a base 114 and a unique identifier 116. The unique identifier 116 may be disposed of on the base 114. The base 114 may be made of any material including, but not limited to, wood, plastic, paper, glass, fiber, a combination thereof, and/or the like. In some aspects, the base 114 may be shaped as a popsicle stick holder (as shown in FIGS. 1-4) that may enable the identifier apparatus 108 to be removably attached or adhered to a popsicle stick via the base 114. In other aspects, the base 114 may be shaped as a drink key (as shown in FIG. 5) that may enable the identifier apparatus 108 to be removably adhered to or “hung/fit around” using a chain to a beverage container/bottle via the base 114. In additional aspects (not shown), the base 114 may have any other shape that may enable the identifier apparatus 108 to be adhered to other artifacts via the base 114 including, but not limited to, plates or bowls for specific food items, drinkware for specific drinks, drink holders that fit around drinking vessels of different shapes and sizes, and/or the like.

In the exemplary aspect where the base 114 is shaped as a popsicle stick holder (as shown in FIGS. 1-4), the base 114 may be an ergonomically safe and comfortable to touch wooden holder. In this case, the base 114 may be made from two pieces of ply (e.g., birch wood ply having a thickness in a range of 0.1-0.5 mm, preferably 0.2 mm), which may be custom laser cut with unique design and glued/attached together to form an indentation or a cavity between the two pieces. The popsicle stick may be inserted into the indentation or cavity to enable removable attachment of the base 114/identifier apparatus 108 with the consumable item 112 (i.e., the popsicle). In some aspects, the base 114 may also include a keychain hole (not shown in FIG. 1) that may enable the user 102 to keep the identifier apparatus 108 as a keychain (or souvenir) when the identifier apparatus 108 may not be attached to the consumable item 112, or to hang the identifier apparatus 108 in user's home, office or any other space as collectible.

In the exemplary aspect where the base 114 is shaped as a drink key (as shown in FIG. 5), the base 114 may be ergonomically safe and comfortable to hold in the palm of user's hand. In this case, the base 114 may be a custom wooden holder cut from a word ply (e.g., ¼ inch thickness birch wood ply). In this case as well, the base 114 may include a keychain hole.

The unique identifier 116, which may be disposed on the base 114, may be associated with the consumable item 112 to which the identifier apparatus 108 may be attached/adhered. In one preferred aspect, the unique identifier 116 may be a Quick Response (QR) code (as shown in FIG. 1). In another preferred aspect, the unique identifier 116 may be an image tag (as shown in FIGS. 2-5). In additional aspects (not shown), the unique identifier 116 may be at least one of a near field communication (NFC) transceiver, a radio frequency identification (RFID) transceiver, an ultra-wideband (UWB) transceiver and a Bluetooth low energy (BLE) transceiver.

In the exemplary aspect when the unique identifier 116 may be a QR code or an image tag, the unique identifier 116 may be custom laser cut or heat transferred onto the base 114. Heat transfer has proven to be more effective for the operations required to be performed in accordance with the present disclosure.

Further, as described above, in addition to the identifier apparatus 108, the system may include the AR unit 110. The AR unit 110 may be implemented in hardware, software (e.g., firmware), or a combination thereof. In some aspects, the AR unit 110 may be part of the identifier apparatus 108. In other aspects, the AR unit 110 may be hosted on a server. In the latter case, in an exemplary aspect, the user device 104 may access the AR unit 110 via an application (“app”) associated with the system that may be installed on the user device 104. The user device 104 may be communicatively coupled with the AR unit 110 via a wireless network. The wireless network may be, for example, a communication infrastructure in which the connected devices discussed in various embodiments of this disclosure may communicate. For example, the wireless network may be and/or include the Internet, a private network, public network or other configuration that operates using any one or more known communication protocols such as, for example, transmission control protocol/Internet protocol (TCP/IP), Bluetooth®, BLE, Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

The AR unit 110 may include a plurality of components including, but not limited to, a transceiver 118, a processor 120 and a memory 122. The transceiver 118 may be configured to receive or transmit signals/information/data from or to a plurality of units/devices (e.g., the user device 104) via the wireless network. The memory 122 may store programs in code and/or store data for performing various operations in accordance with the present disclosure. Specifically, the processor 120 may be configured and/or programmed to execute computer-executable instructions stored in the memory 122 for performing various functions in accordance with the disclosure. Consequently, the memory 122 may be used for storing code and/or data code and/or data for performing operations in accordance with the present disclosure.

The memory 122 may include any one or a combination of volatile memory elements (e.g., dynamic random-access memory (DRAM), synchronous dynamic random access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The memory 122 may be one example of a non-transitory computer-readable medium or memory and may be used to store programs in code and/or to store data for performing various operations in accordance with the disclosure. The instructions in the memory 122 may include one or more separate programs, each of which may include an ordered listing of computer-executable instructions for implementing logical functions.

In further aspects, the memory 122 may include a plurality of databases and modules including, but not limited to, a consumable item information database 124 and an augmented reality image generation module 126. The consumable item information database 124 may be configured to store information associated with the consumable item 112, and a mapping of the unique identifier 116 with the information associated with the consumable item 112. The information associated with the consumable item 112 may include, for example, an ingredient list, a recipe, nutrition information, an ingredient origin, manufacturer details, an art work associated with the consumable item, and/or the like. The augmented reality image generation module 126, as described herein, may be stored in the form of computer-executable instructions, and the processor 120 may be configured and/or programmed to execute the stored computer-executable instructions for performing functions in accordance with the present disclosure.

In operation, when the user 102 desires to know about supplementary/additional information associated with the consumable item 112 or view artwork associated with the consumable item 112, the user 102 may perform a predefined action using the user device 104 in proximity to the identifier apparatus 108 that may be removable adhered/attached to the consumable item 112 (as described above). In some aspects, the predefined action may include scanning the unique identifier 116 by using the user device camera when the unique identifier 116 may be a QR code or an image tag, as shown in FIGS. 1-5. In other aspects, the predefined action may include disposing the user device 104 within a predefined distance (e.g., 0 to 2 feet) from the identifier apparatus 108 when the unique identifier 116 may be an NFC transceiver, an RFID transceiver, a UWB transceiver or a BLE transceiver.

The transceiver 118 may receive (via the wireless network) a command signal associated with the unique identifier 116 from the user device 104 when the user 102 performs the predefined action described above in proximity to the identifier apparatus 108 using the user device 104. The transceiver 118 may then transmit the command signal to the processor 120. Responsive to obtaining the command signals from the transceiver 118, the processor 120 may obtain the information associated with the information associated with the consumable item 112 from the consumable item information database 124 (e.g., by using the mapping of the unique identifier 116 with the information associated with the consumable item 112 stored in the consumable item information database 124).

Responsive to obtaining the information associated with the consumable item 112, the processor 120 may execute instructions stored in the augmented reality image generation module 126 to generate an AR image based on the information associated with the consumable item 112. The processor 120 may then transmit, via the transceiver 118, the generated AR image to the user device 104. The user device 104 may be configured to render the AR image on the display screen 106 over the real-world view that the display screen 106 may be displaying (that may be captured by the user device camera), responsive to receiving the AR image from the AR unit 110.

In this manner, the system, as disclosed in the present disclosure, enable the user 102 to conveniently view the information associated with the consumable item 112 on the display screen 106 of the user device 104. As a first example, as shown in FIG. 2, the display screen 106 may display an AR image 202 associated with the unique identifier 116 (which is shown as an image tag in FIG. 2) over the real-world view when the user 102 scans the unique identifier 116 by using the user device 104. In an exemplary aspect, the AR image 202 may include one or more information associated with the consumable item 112 (e.g., ingredients) to which the identifier apparatus 108 may be attached.

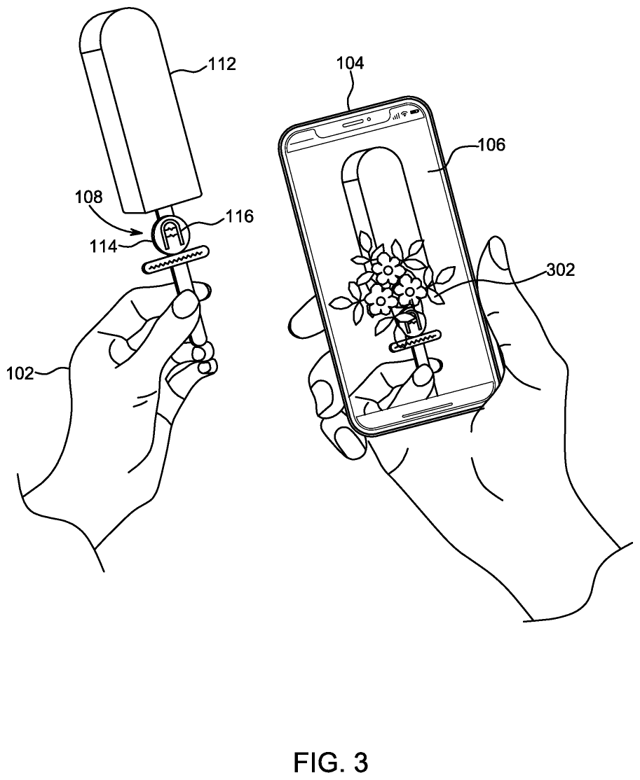

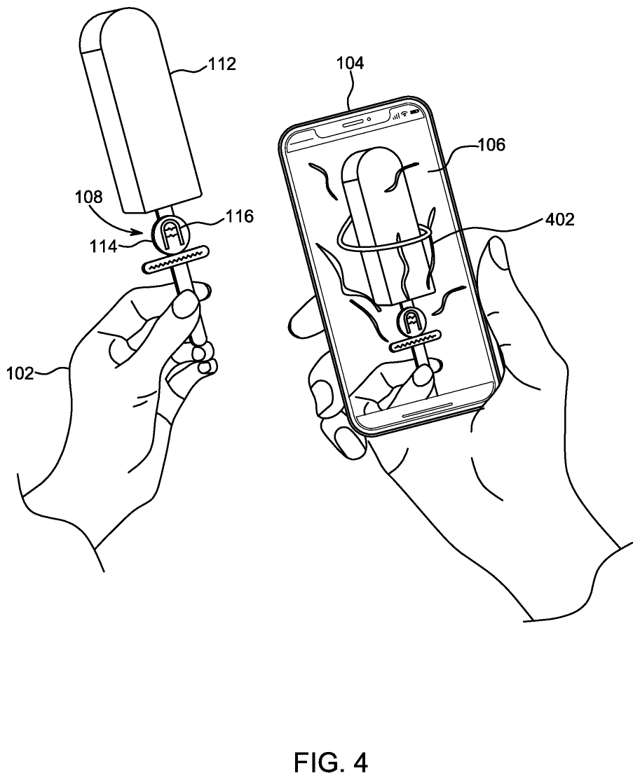

As a second example, as shown in FIG. 3, the display screen 106 may display an AR image 302 associated with the unique identifier 116 (which is shown as an image tag in FIG. 3) over the real-world view when the user 102 scans the unique identifier 116 by using the user device 104. In an exemplary aspect, the AR image 302 may be an art work (shown as flowers) associated with the consumable item 112. [0041.] As a third example, as shown in FIG. 4, the display screen 106 may display an AR image 402 associated with the unique identifier 116 (which is shown as an image tag in FIG. 4) over the real-world view when the user 102 scans the unique identifier 116 by using the user device 104. In an exemplary aspect, the AR image 402 may be another form of art work (shown as fumes) associated with the consumable item 112.

As a fourth example, as shown in FIG. 5, the identifier apparatus 108 may be hung or fit around a beverage bottle 502 and the display screen 106 may display an AR image 504 associated with the unique identifier 116 (which is shown as an image tag in FIG. 5) over the real-world view when the user 102 scans the unique identifier 116 by using the user device 104. In an exemplary aspect, the AR image 504 may include one or more information associated with the beverage included in the beverage bottle 502 (e.g., ingredients) or information about the beverage bottle 502 itself.

In the exemplary aspect depicted in FIG. 5, the processor 120 may cause the display screen 106 to display a plurality of different types of AR images (not shown). For example, in some aspects, the user 102 may use the user device 104 as a wand (or in a cursor type manner), which allows the user 102 to manipulate the AR image being displayed on the display screen 106 or even change the AR image being displayed. Further, in other aspects, the AR image may show a digital interactive liquid spilled out of the AR image (or the unique identifier 116) when the user device 104 may be passed from hand to hand amongst one or more users for an engaging experience with the beverage coming to life and telling its story.

A person ordinarily skilled in the art may appreciate from the description above that the system described in the present disclosure combines food and art experiences through digital technologies and custom product designs. Physical and digital forms are intentionally designed to reveal layers of story beyond what is seen by the naked eye. Digital devices, such as the user device 104, align imagery to physical components to reveal visuals that extend reality.

The system creates synergetic spaces and experience to collaborate, inform, inspire and innovate. The system creates a unique and accessible connection between a specific food or beverage and its unique story through the assistance of digital art, instigated by the custom designed identifier apparatus 108/base 114. Communicating source, origin, and ingredients of the products (e.g., the consumable item 112) with digital storytelling, play and art allows the user 102 to not only learn about the roots of what the user 102 may be ingesting, but also creates a recurring platform for digital artists to make meaningful work and expand reality into a product source of community building and cultural development. This use of interactive storytelling engages the user 102, which can elicit a deeper connection to the food-beverage as a medium.

Embodiments described in the present disclosure may further include presenting information about sources of ingredients, stories related to food items being presented, and relevant creative processes and data sets. Commercial applications of the present disclosure include, but are not limited to, the ability to showcase important branding and product information or stories by the manufacturers through augmented or mixed reality techniques for a unique delivery of information to the user 102. This encourages brand engagement and marketing strategies that connect new trends in technology with the food and beverage industry. In the food and beverage industry, new or custom designs of the identifier apparatus 108 may be applied to mass markets. For example, the popsicle holders or drink tags described above may be applied to large scale popsicle manufacturing nationally or internationally on a large scale production.

When approaching an experience using the system disclosed in the present disclosure, the user 102 first encounters something familiar and accessible to understand, such as a popsicle or drink bottle. As the experience continues, the layers of interactivity reveal a deeper meaning and encourage the user 102 to engage with a story relevant to what the user 102 is ingesting. The user 102 will notice an object that will have a familiar user interface, such as a QR code, which will encourage the user 102 to pull out the user device 104 and scan it for next steps.

Furthermore, identifier apparatuses (such as the identifier apparatus 108) may become a series of evolving collectibles that can be curiosities bridging users' physical and digital world, as the society moves towards a bridged approach to everyday interactions with the Internet of Things (IoT).

Embodiments of the present disclosure may include unique identifier apparatuses (or anchor objects) designed to seamlessly integrate the technological aspect with the food/beverage form, to disarm users that are reticent of new technologies, using nostalgic and familiar forms to create a moment of surprise and delight. Combination of unique identifier apparatus design with augmented/mixed reality specific tag alignment and food placement creates a unique experience of flavor, form and digital artwork interactivity that may be easily shared.

Other embodiments of the present disclosure may use image recognition so that no identifier apparatus or tag may be needed to bring up specific information about a specifically shaped food or object. Additional embodiments may include tags on a plurality of objects. For example, a tag may be applied to a plate that brings up unique information related to the food on the plate, a drink holder or koozie, a specialized mug or cup, or other drinkware or plateware. Further embodiments may include removable tags that may be applied to a variety of different media. Such tags may be printed, e.g., stickers, or tags that are on wood or plastic or attached through methods such as adhesive or mechanical attachment.

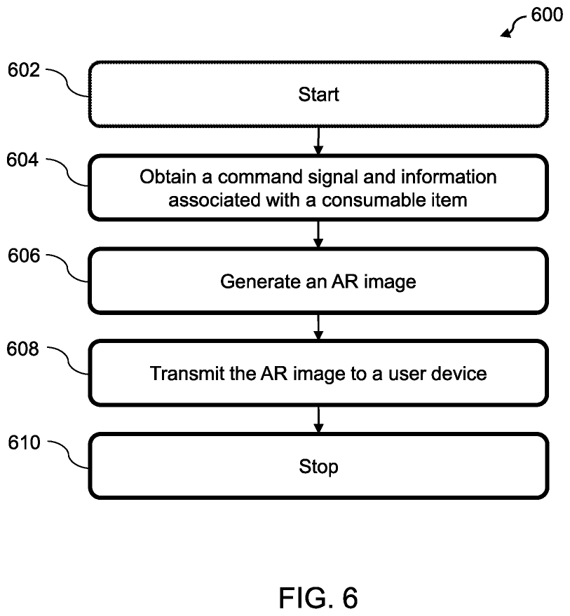

FIG. 6 depicts a flow diagram of an example method 600 to enable display of an augmented reality (AR) image on the user device 104 in accordance with the present disclosure. FIG. 6 may be described with continued reference to prior figures, including FIGS. 1-5. The following process is exemplary and not confined to the steps described hereafter. Moreover, alternative embodiments may include more or less steps than are shown or described herein and may include these steps in a different order than the order described in the following example embodiments.

Referring to FIG. 6, at step 602, the method 600 may commence. At step 604, the method 600 may include obtaining, by the processor 120, the command signal from the transceiver 118 (that the transceiver 118 receives from the user device 104) and the information associated with the consumable item 112 from the consumable item information database 124. At step 606, the method 600 may include generating, by the processor 120, the AR image based on the information associated with the consumable item 112 responsive to obtaining the command signal. At step 608, the method 600 may include transmitting, by the processor 120 via the transceiver 118, the AR image to the user device 104.

At step 610, the method 600 may stop. In some embodiments additional steps are included such as going to a website outside the AR experience or interaction within the AR experience such as game-like mechanics (for instance, “tap here to reveal”).

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system configured to enable display of an augmented reality (AR) image on a user device, the system comprising:
an identifier apparatus removably attached to a consumable item, wherein the identifier apparatus comprises a unique identifier associated with the consumable item;
an AR unit comprising:
a transceiver configured to a receive a command signal associated with the unique identifier from the user device when the user device performs a predefined action in proximity to the identifier apparatus;
a memory configured to store information associated with the consumable item; and
a processor communicatively coupled with the transceiver and the memory, wherein the processor is configured to:
obtain the command signal and the information associated with the consumable item;
generate the AR image based on the information associated with the consumable item responsive to obtaining the command signal; and
transmit the AR image to the user device.

2. The system of claim 1, wherein the user device renders the AR image on a user device display screen responsive to receiving the AR image.

3. The system of claim 1, wherein the predefined action comprises scanning the unique identifier using a user device camera.

4. The system of claim 1, wherein the predefined action comprises disposing the user device within a predefined distance from the identifier apparatus.

5. The system of claim 1, wherein the consumable item is at least one of a food item and a beverage item.

6. The system of claim 1, wherein the unique identifier is a Quick Response (QR) code.

7. The system of claim 1, wherein the unique identifier is an image tag.

8. The system of claim 1, wherein the unique identifier is at least one of a near field communication (NFC) transceiver, a radio frequency identification (RFID) transceiver, an ultra-wideband (UWB) transceiver and a Bluetooth low energy (BLE) transceiver.

9. The system of claim 1, wherein the AR unit is hosted on a server.

10. The system of claim 1, wherein the AR unit is part of the identifier apparatus.

11. The system of claim 1, wherein the information associated with the consumable item comprises at least one of an ingredient list, a recipe, nutrition information, an ingredient origin and an art work associated with the consumable item.

12. The system of claim 1, wherein the identifier apparatus further comprises a base, and wherein the unique identifier is disposed on the base.

13. The system of claim 12, wherein the base is made of at least one of wood, plastic, paper and glass.

14. The system of claim 12, wherein the base is a popsicle stick holder.

15. The system of claim 12, wherein the base is a drink key.

16. A method to enable display of an augmented reality (AR) image on a user device, the method comprising:
obtaining, by a processor, a command signal from a transceiver and information associated with a consumable item from a memory, wherein:
the transceiver is configured to a receive the command signal associated with a unique identifier from the user device when the user device performs a predefined action in proximity to an identifier apparatus,
the identifier apparatus removably attached to a consumable item, and
the identifier apparatus comprises the unique identifier associated with the consumable item;
generating, by the processor, the AR image based on the information associated with the consumable item responsive to obtaining the command signal; and
transmitting, by the processor, the AR image to the user device.

17. The method of claim 16, wherein the predefined action comprises scanning the unique identifier using a user device camera.

18. The method of claim 16, wherein the consumable item is at least one of a food item and a beverage item.

19. The method of claim 16, wherein the unique identifier is a Quick Response (QR) code.

20. A non-transitory computer-readable storage medium in a distributed computing system, the non-transitory computer-readable storage medium having instructions stored thereupon which, when executed by a processor, cause the processor to:
obtain a command signal from a transceiver and information associated with a consumable item from a memory, wherein:
the transceiver is configured to a receive the command signal associated with a unique identifier from a user device when the user device performs a predefined action in proximity to an identifier apparatus,
the identifier apparatus removably attached to a consumable item, and
the identifier apparatus comprises the unique identifier associated with the consumable item;
generate an Augmented Reality (AR) image based on the information associated with the consumable item responsive to obtaining the command signal; and
transmit the AR image to the user device.
